(19) United States
(12) Patent Application Publication
(10) Pub. No.: US 2020/0165864 A1
(43) Pub. Date: May 28, 2020

(54) SHIELD FOR MOBILE HOME DOOR

(71) Applicant: Guy MacDonald, Clinton Twp., MI (US)

(72) Inventor: Guy MacDonald, Clinton Twp., MI (US)

(21) Appl. No.: 16/695,903

(22) Filed: Nov. 26, 2019

Related U.S. Application Data
(60) Provisional application No. 62/771,333, filed on Nov. 26, 2018.

(51) Int. Cl. E06B 7/26

(52) U.S. Cl. CPC E06B 7/26

(57) ABSTRACT

A shield for enshrouding the door of a mobile home or manufactured home includes a first elongated strip which extends along the length of a co-extensive molding of a door of a manufactured home or mobile home. A top element overlies the top of the door and extends horizontally outwardly from the wall of the home beyond the top of the door. A connector interconnects the top strips. The strips of the shield have a width which is wider than the door such that the door is nested within the space defined by the strips.

### CROSS REFERENCE TO RELATED APPLICATION

This application is a completion application of co-pending U.S. Provisional Patent Application Ser. No. 62/771,333, filed Nov. 26, 2018, for “SHIELD FOR MOBILE HOME DOOR”, the disclosure of which is hereby incorporated by reference in its entirety, including the drawings.

### BACKGROUND OF THE INVENTION

### 1. Field of the Invention

The present invention pertains to mobile homes. More particularly, the present invention concerns the doors for mobile homes. Even more particularly, the present invention concerns shields, or encasements for the doors for mobile homes.

### 2. Prior Art

As is known to those skilled in the art to which the present invention pertains, typically, the doors for mobile homes sit flush with the actual exterior wall of the mobile home. There is no overhang or similar protection about the door. There are no gutters that drain the water away from the sides where there is a downpour, and, similarly, there is little or no protection about the door during a heavy wind, as well.

As a consequence of this lack of protection, the doors and the encasement therearound are subject to corrosion based upon the materials of construction ordinarily used with respect to such doors. This necessitates replacement and a shortened use or life span.

Similarly, a heavy wind can damage the door, break any glass, as well as tear the door from its hinges.

The present invention, as will subsequently be detailed, seeks to alleviate this situation by providing a shielding for such doors.

### SUMMARY OF THE INVENTION

The present invention provides a shield which, generally, comprises a shield including an elongated first strip or element which is abutted against a door flashing or molding along the non-hinged side of a door and a top piece which overlies the top of the door and which, again, is installed over the flashing.

The first strip is co-extensive with the length or height of the door.

A connector interconnects the top piece and the side piece to form a unitary shield.

Optionally, an elongated second side element or strip can be disposed on the side opposite the elongated first piece to totally enshroud the side and top of the door.

Also, a brace spanning the width of the door can be connected to the two side elements where in those instances there is a screen door which may need stabilization.

For a more complete understanding of the present invention reference is made to the following detailed description and accompany drawing. In the drawing like reference characters refer to like part throughout the several views in which:

### BRIEF DESCRIPTION OF THE DRAWING

FIG. 1 is an environmental view showing a conventional side wall of a mobile home with an outer door;

FIG. 2 is a partial environmental view showing the installation of the shield hereof in accordance with the present invention;

FIG. 3 is a broken perspective view of one piece of the shield hereof;

FIG. 4 is a side view of a connector for joining the two pieces of the shield;

FIG. 5 is a perspective elevational view showing the shield installed around a door; and

FIG. 6 is a perspective view of an alternate embodiment of an installation of the shield.

### DESCRIPTION OF THE INVENTION

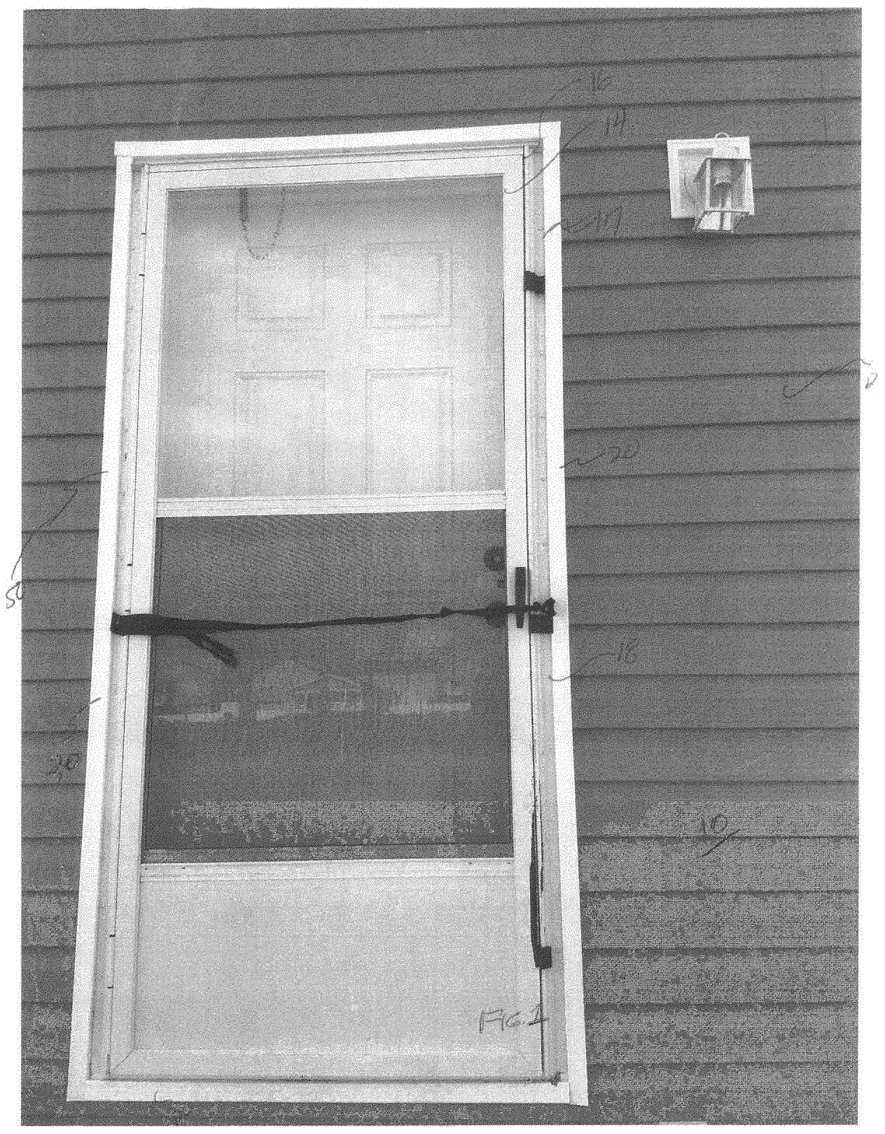

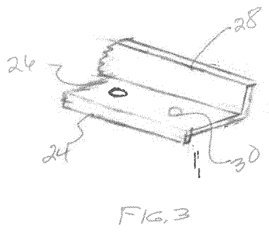

Now, in accordance with the present invention and with reference to FIGS. 1-5, there is depicted therein, generally, a wall of a mobile home, generally, denoted at 10. The mobile home includes a sidewall 12, having an access door 14, which permits ingress and egress into the interior and out of the interior of the home 10.

The door is mounted in a conventional manner, having a jamb 16 and a frame 17. The door is secured to the sidewall at the jamb, typically, via threaded fasteners 18, or the like.

Ordinarily, a molding 20 surrounds the door to provide a finished look to the door. Optionally, a flashing is used to seal the door and/or direct moisture away from the door.

However, the flashing, which ordinarily is a tape, is interposed the sidewall and the molding, is inadequate for addressing heavy rains and winds.

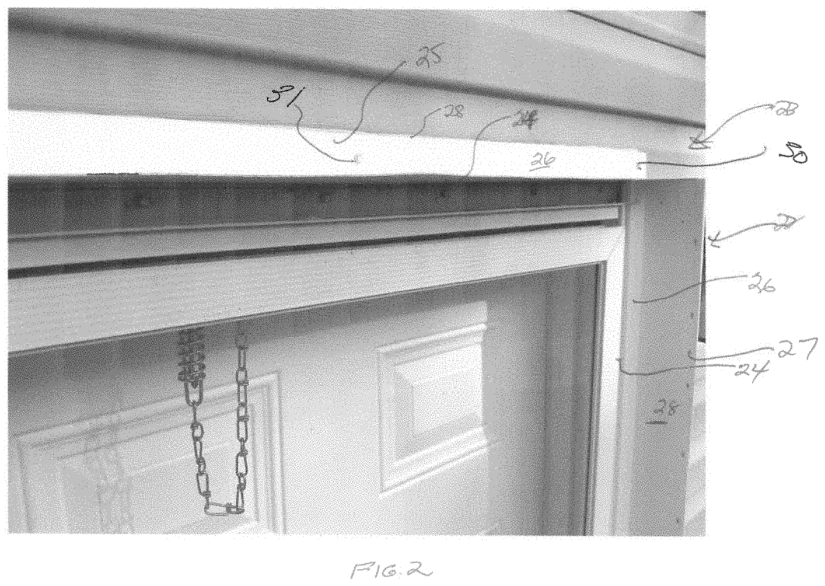

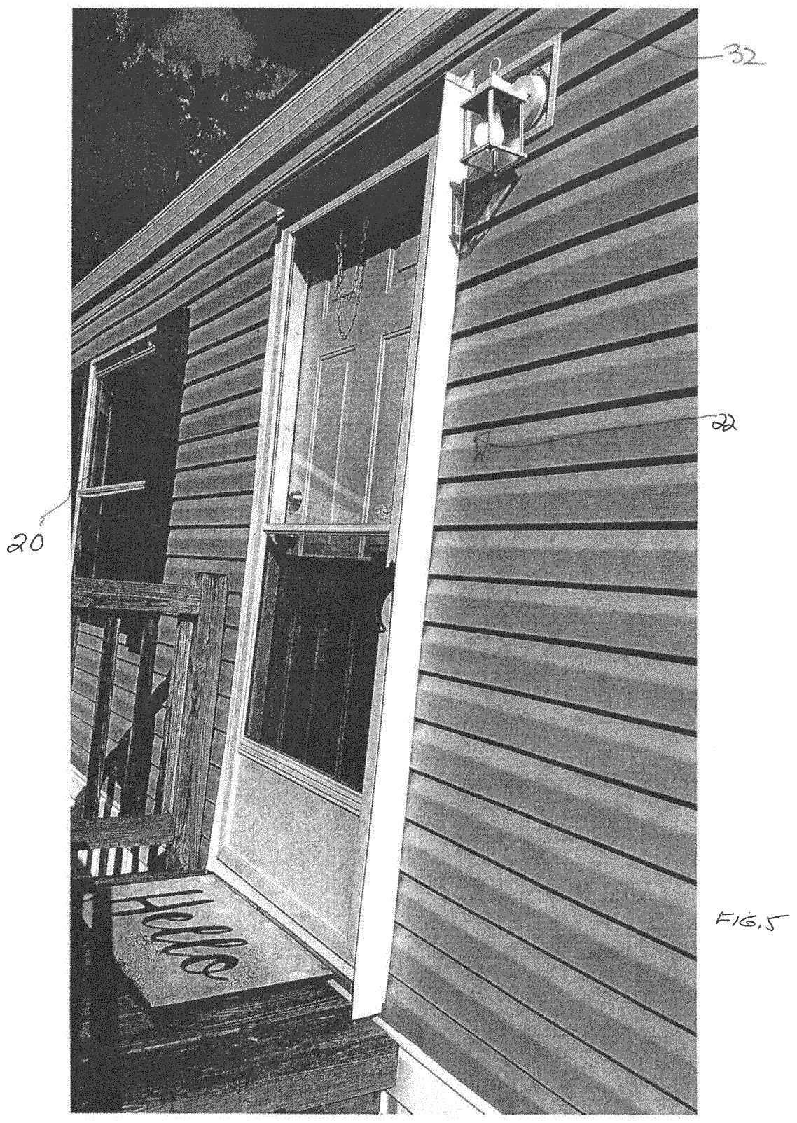

Thus, in accordance herewith and as shown in FIGS. 2 and 5, a shield 22 is displayed which surrounds the top and the “free” or unhinged side of the door 14 and the molding 20 to provide protection against the inclement weather conditions described above.

The shield comprises a two-piece assembly 23, having elements 25 and 27. The first element or piece 25 is denoted as the top piece and the second element or piece 27 is denoted as the side piece.

Each piece comprises a stepped mounting including a first strip or leg 24, an intermediate strip or leg 26 integrally formed with and substantially perpendicular or normal to the first leg 24 and a third leg 28 integral with the second leg 26 and disposed substantially normal thereto and parallel to the first leg. The pieces are different in length.

A plurality of apertures 30 are formed along the extent of the intermediate legs, which receive fasteners 31 which are used to secure each piece of the shield to the wall 12 of the mobile home 10.

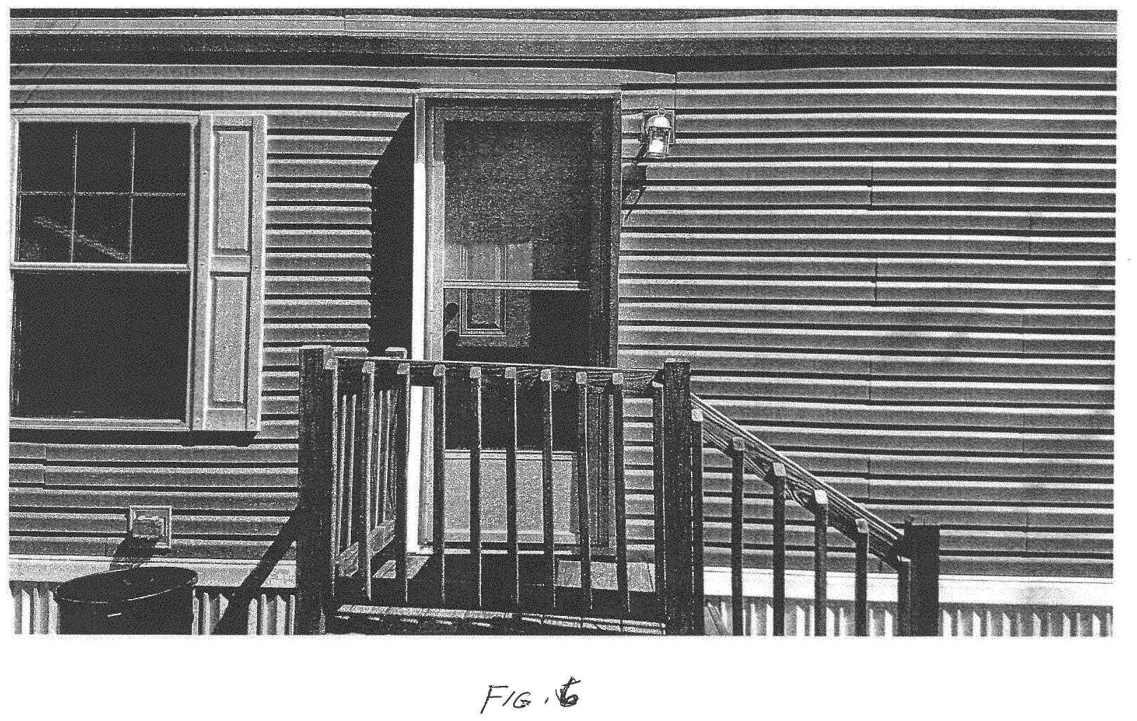

Optionally, and as shown in FIG. 6, a third strip or piece 50 may be disposed on the side of the door opposite that of the side element 27 to thereby totally encase the sides and top of the door.

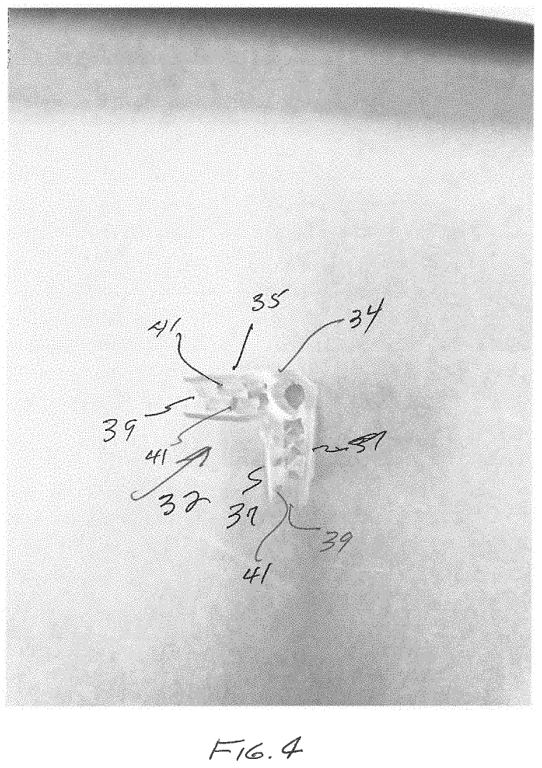

As shown in FIGS. 4 and 5 a connector 32 is used to interconnect the top piece 25 to the side piece 27 to provide the assembly.

The connector 32 is a right-angle bracket 34 having a width equal to that of the intermediate legs. As shown the connector is a clamp having a first right-angled plate 35 and a second right-angled plate 37 with a space or gap 39 having inwardly directed teeth 41 disposed therewithin such that the connector clamps to the intermediate leg of each piece to interconnect them.

It is to be appreciated from the preceding that the door essentially nests within the shield hereof with the top piece overhanging the door to prevent and preclude exposure to inclement weather during normal weather conditions.

To install the shield and as shown in FIG. 2, in each instance, the leg 24 is abutted against a door flashing or molding, such that the leg 28 projects outwardly from the sidewall 12 a sufficient distance to overlie the top of the door and the free side of the door, respectively. Threaded fasteners project through suitable apertures formed in each intermediate leg to secure the associated piece to the sidewall 12.

It is to be appreciated that during inclement weather, such as a rainstorm, rain will hit or impinge upon the shield and be deflected away from the door thereby extending its useful life. Similarly, during a heavy wind, the shield will deflect wind away from the door.

It is also to be readily appreciated that the present assembly may be readily packaged as a kit. Further, each component may be fabricated from a durable plastic such as PVC or the like.

Having, thus, described the invention what is claimed is:

1. A shield for enshrouding a door which comprises:
(a) a first elongated element which extends along the vertical extent of a door;
(b) a second elongated element which overlies the top of the door; and
(c) means for interconnecting the first and second elements.

2. The shield of claim 1 wherein each element comprises a first leg, a second leg normal to the first leg and, a third leg which extends normal to the second leg such that the first and third legs are parallel to each other, the third leg being mountable to a door mounting adjacent the door.

3. The shield of claim 1 which further comprises a third elongated element which is mountable on the side opposite that of the first element on the side of the door.

4. The shield of claim 3 which further comprises a stabilizing bar which traverses the width of a door and extends between the first and third elements.

5. An assemblable kit for enshrouding a door of a mobile home or manufactured home and which comprises:
(a) a first elongated element which extends along the vertical extent of a door;
(b) a second elongated element which overlies the top of the door; and
(c) means for interconnecting the first and second elements.

6. The kit of claim 5 which further includes a third element which is mountable on the side opposite that of the first element on the side of the door.
